(19) United States
(12) Patent Application Publication
(10) Pub. No.: US 2013/0155108 A1
(43) Pub. Date: Jun. 20, 2013

(54) Augmented Reality User Interaction Methods, Computing Devices, And Articles Of Manufacture

(71) Applicants: Mitchell Williams, Liberty Lake, WA (US); Damon Buck, Spokane, WA (US)

(72) Inventors: Mitchell Williams, Liberty Lake, WA (US); Damon Buck, Spokane, WA (US)

(21) Appl. No.: 13/473,466

(22) Filed: May 16, 2012

Related U.S. Application Data
(60) Provisional application No. 61/576,295, filed on Dec. 15, 2011.

(51) Int. Cl. G09G 5/00

(52) U.S. Cl. 345/633

(57) ABSTRACT

Augmented reality user interaction methods, computing devices, and articles of manufacture are disclosed according to some aspects of the description. In one aspect, an augmented reality user interaction method includes executing an augmented reality browser application, displaying a camera view of a computing device wherein images generated by a camera are displayed using a touch sensitive display, during the displaying the camera view, displaying an icon interface comprising a pathway and a plurality of icons with respect to the pathway using the touch sensitive display, first detecting a user input moving in a direction of the pathway, moving the icons along the pathway in the direction of the user input as a result of the first detecting, second detecting a user input selecting one of the icons, and depicting augmented reality content with respect to at least one of the images as a result of the second detecting.

This application claims priority to a U.S. Provisional Patent Application titled “User Interface” filed Dec. 15, 2011 having Ser. No. 61/576,295, the teachings of which are incorporated herein by reference.

### TECHNICAL FIELD

This disclosure relates to augmented reality user interaction methods, computing devices, and articles of manufacture.

### BACKGROUND

Augmented reality (AR) devices add augmented reality content into scenes captured by cameras, which may be included in the devices. In some augmented reality implementations, users sort through pages and make several selections to configure their augmented reality devices as desired. A user may also navigate to other pages when they would like to search for additional content that might be available in augmented reality.

At least some aspects of the present disclosure are directed towards facilitating user interactions with respect to a computing device including facilitating user operations with respect to implementing augmented reality operations in one embodiment.

### BRIEF DESCRIPTION OF THE DRAWINGS

FIG. 1 is an illustrative representation of example augmented reality operations according to one embodiment.

FIG. 2 is a functional block diagram of a computing device according to one embodiment.

FIG. 3 is an illustrative representation of a user interface according to one embodiment.

FIG. 4 is a flow chart of an augmented reality method according to one embodiment.

### DETAILED DESCRIPTION

Some aspects of the disclosure described herein are directed towards apparatus, methods and programming for user interfaces of computing devices. In one embodiment, management of a plurality of icons of a user interface is provided. For example, one user interface example of the disclosure provides display of user icons, movement of the icons, and selection of the icons. In some implementations, the user interfaces may be utilized with respect to controlling or implementing augmented reality operations where the physical world is augmented with additional information, such as virtual objects. For example, images of the physical world observed through computing devices may be augmented or enhanced with augmented reality representations, for example in the form of visual and/or audio data which may be experienced by users. In one example embodiment, augmented reality representations may include virtual objects which augment a user's experience of the physical world. In one specific embodiment described herein, a user interface for an augmented reality browser is provided which enables a user to view different icons for controlling or implementing operations of the augmented reality browser. Computing devices configured to implement augmented reality operations may be described as augmented reality devices in some embodiments.

According to one embodiment, an augmented reality user interaction method comprises using a computing device, executing an augmented reality browser application, during the executing, displaying a camera view of the computing device wherein a plurality of images generated by a camera of the computing device are displayed using a touch sensitive display, during the displaying of the camera view, displaying an icon interface comprising a pathway and a plurality of icons with respect to the pathway using the touch sensitive display, first detecting a user input moving in a direction of the pathway, moving the icons along the pathway in the direction of the user input as a result of the first detecting, second detecting a user input selecting one of the icons, and depicting augmented reality content with respect to at least one of the images as a result of the second detecting.

According to an additional embodiment, a computing device comprises a display screen configured to depict an icon interface comprising a plurality of icons and a pathway, and to receive user inputs interacting with the display screen, processing circuitry configured to control the display screen to depict the icon interface, to access the user inputs, and to control operations of the computing device as a result of the accessed user inputs, and wherein the processing circuitry is configured to access one of the user inputs interacting with the icon interface depicted using the display screen and to control movement of the icons along the pathway of the icon interface as a result of accessing one of the user inputs.

According to still another embodiment, an article of manufacture comprises storage media storing programming which causes processing circuitry of the computing device to perform processing comprising using a display screen, displaying a pathway and a plurality of icons at a plurality of different locations of the pathway, accessing a user input with respect to the display screen, as a result of the user input, moving the icons along the pathway, as a result of a second user input, selecting one of the icons, and implementing an operation of the computing device as a result of the selecting one of the icons.

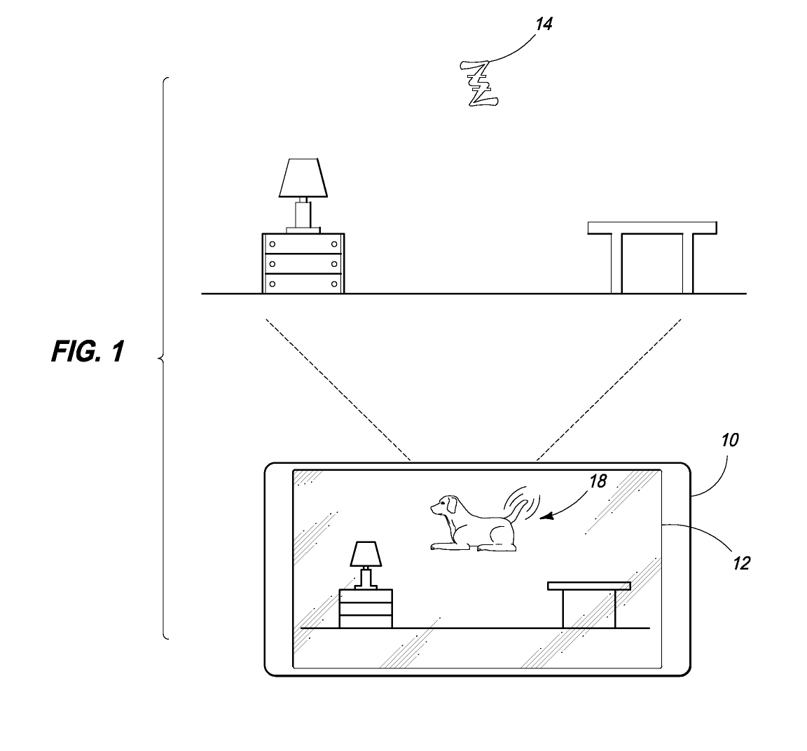

Referring to FIG. 1, one example of augmented reality aspects of the disclosure is described. FIG. 1 illustrates a computing device 10 which is used to generate an image of the physical world and which is augmented by an augmented reality representation. More specifically, in the example of FIG. 1, the computing device 10 includes a camera (not shown) which is configured to capture images of the physical world and which may be depicted using a display screen 12. As a user moves the computing device 10, a plurality of images are captured of different scenes viewed by the camera of the device 10.

In the illustrated example, the scene viewed by the device 10 includes a marker 14 on a wall of the physical world. The generated image depicted using the display screen 12 includes an augmented reality representation 18 which augments a user's experience of the physical world by replacing the physical world marker 14 with the representation 18. In the illustrated example, the augmented reality representation 18 is a virtual 3D object in the form of a puppy, which may be selected by another user to be associated with the marker 14.

The use of marker 14 is one example of augmented reality operations which may be implemented using the computing device 10 and other augmented reality operations may be implemented in other embodiments. For example, virtual objects may be associated with other physical objects of the physical world, such as other computing devices 10 (not shown), in images generated by device 10. In some embodiments, augmented reality representations 18 may entirely replace physical objects of the physical world.

In one more specific example, the augmented reality representations 18 may include advertising objects (e.g., banner with a product name) and the representations 18 may be associated with famous physical structures of the physical world when observed through a computing device 10. For example, a user at a significant football game may view a virtual object banner draped between the physical world goalposts when a user of a device 10 captures images of the end zone during a football game. Companies may pay advertising fees to have augmented reality representations of advertisements of their products associated with physical world objects and which may be viewed by users using their computing devices 10 who are proximately located to the physical world objects in one embodiment. Although the above examples are discussed with respect to augmented graphical content, other types of augmented reality content which may be provided by computing device 10. Examples of augmented reality content include rendering images, static 3-dimensional (3D) models, animated 3D models, videos, videos with alpha channels, sound, and text.

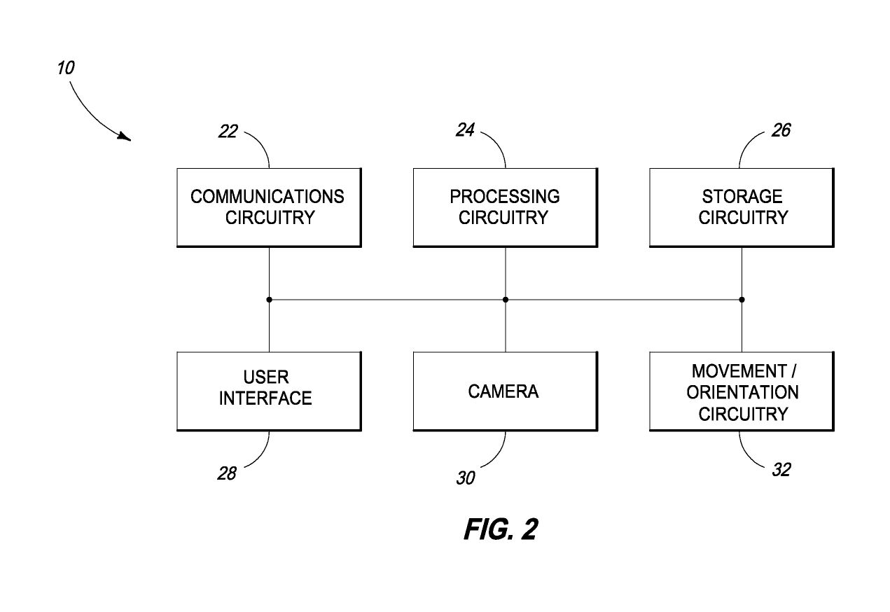

Referring to FIG. 2, one example embodiment of a computing device 10 is shown. The illustrated system 10 includes communications circuitry 22, processing circuitry 24, storage circuitry 26, a user interface 28, a camera 30 and movement/orientation circuitry 32. Some examples of computing devices 10 include mobile devices, smartphones, notebook computers, and tablets although aspects of the disclosure may be utilized in other computing devices and which may also be configured to implement augmented reality operations in some implementations. Other embodiments of computing device 10 are possible including more, less and/or alternative components.

Communications circuitry 22 is arranged to implement communications of computing device 10 with respect to external devices or systems implemented as other computing devices 10, Wi-Fi communications devices, or cellular infrastructure. Communications circuitry 22 may be configured to implement wired and/or wireless communications.

In one embodiment, processing circuitry 24 is arranged to process data, control data access and storage, issue control signals or commands, and control other augmented reality operations. For example, processing circuitry 24 may process scenes captured by camera 30 to identify markers and process and modify images to include augmented reality content.

Processing circuitry 24 may comprise circuitry configured to implement desired programming provided by appropriate computer-readable storage media in at least one embodiment. For example, the processing circuitry 24 may be implemented as one or more processor(s) and/or other structure configured to execute executable instructions including, for example, software and/or firmware instructions. Other embodiments of processing circuitry 24 include hardware logic, PGA, FPGA, ASIC, state machines, and/or other structures alone or in combination with one or more processor(s). These examples of processing circuitry 24 are for illustration and other configurations are possible.

Storage circuitry 26 is configured to store programming such as executable code or instructions (e.g., software and/or firmware), electronic data, databases, image data, augmented data, identifiers, location information, augmented reality data, and/or other digital information and the storage circuitry 26 may include computer-readable storage media. At least some embodiments or aspects described herein may be implemented using programming stored within one or more computer-readable storage medium of storage circuitry 26 and configured to control appropriate processing circuitry 24.

The computer-readable storage medium may be embodied in one or more articles of manufacture which can contain, store, or maintain programming, data and/or digital information for use by or in connection with an instruction execution system including processing circuitry 24 in the exemplary embodiment. For example, computer-readable storage media may include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

User interface 28 is configured to interact with a user including conveying data to a user (e.g., displaying visual images for observation by the user) as well as receiving inputs from the user, for example, via a graphical user interface (GUI). User interface 28 may be configured differently in different embodiments. One example embodiment of user interface 28 is implemented as display screen 12 which may be interactive (e.g., a touch sensitive screen or touchscreen). Accordingly, display screen 12 may be configured to display images and receive user inputs interacting with displayed images.

For example, a display screen 12 of user interface 28 may utilize different technologies, such as resistive, surface acoustic wave, capacitive, infrared, or optical imaging to detect presence and location of user interactions, such as touches (e.g., fingertip, hand, stylus, other), upon the display screen 12 of the user interface 28. The user inputs may interact directly with displayed images of the display screen without use of intermediate devices, such as a mouse. Other embodiments of user interface 28 are possible, such as including a mouse or other pointing device for user interactions.

Camera 30 is configured to generate images of scenes within its field of view. In one embodiment, camera 30 generates image data of the scenes of the physical world viewed by the computing device 10 in one embodiment. An example camera 30 includes an appropriate imaging sensor configured to generate digital image data responsive to received light in one implementation.

Movement/orientation circuitry 32 is configured to provide information regarding movement and orientation of the computing device 10 in the described embodiment. For example, circuitry 32 may include an accelerometer arranged to provide information regarding forces which the computing device is subjected to. Circuitry 32 may also include a compass and inclinometer configured to provide information regarding an orientation of the computing device 10 in the physical world, and location data, such as GPS circuitry configured to provide information regarding a location of the computing device 10 in the physical world.

As discussed above, some aspects of the disclosure are utilized in computing devices which are configured to implement augmented reality operations. In some augmented reality implementations, a computing device 10 may execute an augmented reality browser and be configured thereby to detect markers and augment real world images with augmented reality content. For example, the computing device may detect markers (e.g., QR codes, marker 14 of FIG. 1, etc.), and augment representations of the real world, such as images, with augmented reality content as a result of the detection of the markers. One example augmented reality browser is the browsAR™ application provided by the assignee hereof and available from the App Store of Apple Inc. and the Android Market.

The camera view function or mode of a computing device 10, such as a smartphone, is often utilized in augmented reality applications where images of the real world are generated during the camera view and augmented with additional AR content. Accordingly, in some embodiments, augmented reality user interface methods and user interfaces (UI) for augmented reality devices are centered around the camera view of the computing device 10 while providing an ergonomically improved experience for the user. Furthermore, at least some aspects of the disclosure facilitate navigation to different pages or controlling operations of an augmented reality browser. While some embodiments of this disclosure are described with respect to the camera view and augmented reality functionality for illustrative examples, the user interface may be implemented with respect to different applications or functions of a computing device 10 in other examples.

A user may make selections of their computing device 10 to experience augmented reality. In addition, a user may want to search for different augmented reality content on-the-fly, for example, while experiencing augmented reality, and accordingly, may access or navigate different pages during an augmented reality experience. At least some aspects of the disclosure facilitate user interactions with respect to the computing device 10 including implementing augmented reality operations in some specific examples.

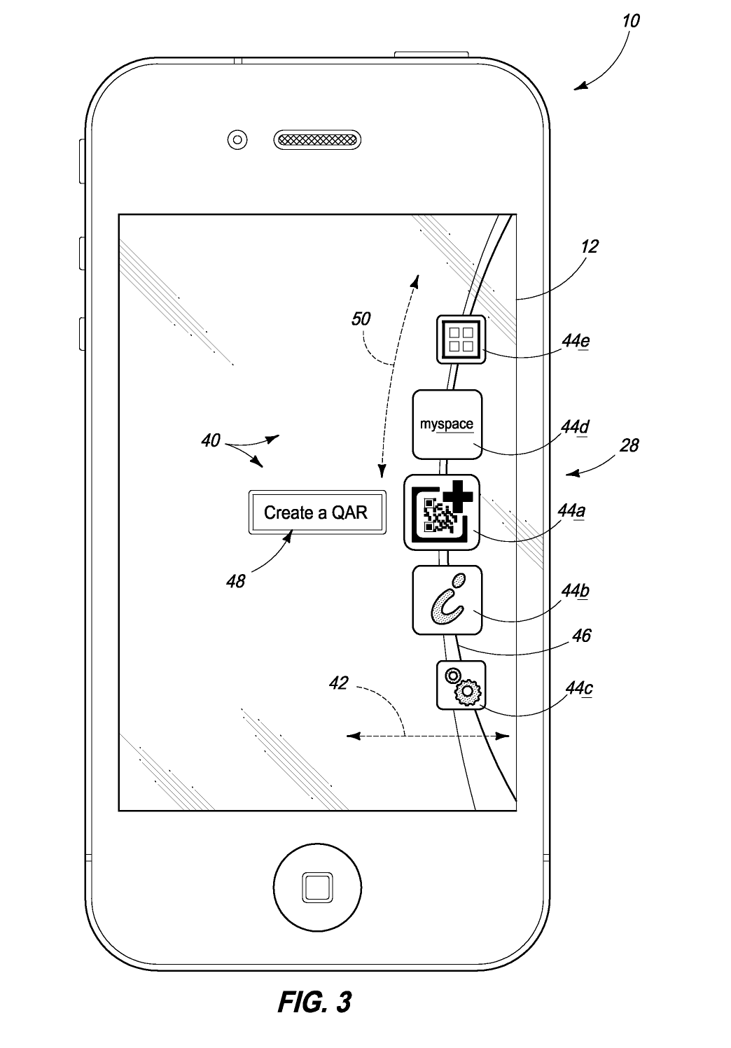

Referring to FIG. 3, an example computing device 10 embodied as a smartphone is shown. The example computing device 10 includes a display screen 12 which provides a user interface 28 for user interaction. In one embodiment, a user may be experiencing augmented reality content with respect to images captured by a camera and displayed on the display screen 12. During an augmented reality experience, the user may wish to access other pages, applications or functionality of the computing device 10. In one embodiment, computing device 10 is configured to control the user interface 28 to display an icon interface 40 to assist the user with accessing other pages, applications, device functionality, device operations, etc.

In one embodiment, the icon interface 40 is displayed adjacent to a side of the display screen 12. Displaying the icon interface 40 as shown allows the user to easily access and manipulate the icon interface 40 using their right thumb while holding the computing device 10 thereby facilitating user operation of the computing device 10 in an ergonomically-pleasing manner. In one embodiment, the computing device 10 is configured to detect a user input indicating a desire to activate and access the icon interface 40.

In one more specific example, the computing device 10 is configured to monitor areas adjacent to the left or right sides of the display screen 12 and to detect a user input in the form of a horizontal swiping motion 42 adjacent to one of the left and right sides of the display screen 12. The computing device 10 displays the icon interface 40 as a result of an appropriately detected motion 42 adjacent to either the left or right sides of the display screen 12 in the described example.

More specifically, the computing device 10 may detect a leftward horizontal swipe 42 of a user's right thumb, and as a result of the detection, slide the icon interface 40 from the right edge of the display screen 12 to its depicted location of FIG. 3 to permit a user to access a plurality of icons 44a-e of the icon interface 40. Computing device 10 may also be configured to detect rightward swiping motions 42 adjacent to the left side of display screen 12, and may slide the icon interface 40 from the left edge of the display screen 12 to a location adjacent to the left side of the display screen 12. Other user inputs (e.g., pressing a button) may be utilized to activate and display the icon interface 40 in other embodiments. Furthermore, the icon interface 40 may also be displayed automatically without user activation in some implementations.

The computing device 10 is shown in a portrait orientation in the example illustration of FIG. 3. In other embodiments, the computing device 10 may also be provided in a landscape orientation, and the icon interface 40 may be displayed adjacent to the left and right sides of the display screen 12 when oriented in a landscape orientation. In one embodiment, the configuration and placement of the icon interface 40 adjacent to a side of the display screen 12 permits a user to easily access and manipulate the icon interface 40, for example using their thumb, as discussed above.

The displayed example icon interface 40 of FIG. 3 includes a pathway 46 and a plurality of icons 44a-e which are positioned at different locations of the pathway 46. In one embodiment, the icons 44a-e are only depicted along the pathway 46 and the pathway 46 may be considered to restrict the display of the icons 44a-e to a predefined area of the display screen 12 (e.g., adjacent to the right or left side of the display screen 12). The restriction of the location of the icon interface 40 and the displayed icons 44a-e leaves other areas available for the display of other information, such as images which are generated by the camera in the camera view.

Following the activation and display of the icon interface 40, a user may manipulate and select displayed icons 44a-e of the icon interface 40. In one embodiment, the icon interface 40 is embodied as a slider control including a pathway 46 and the icons 44a-e are arranged adjacent to different locations of the pathway 46. A user may select an icon 44a-e via an appropriate user input. For example, the user may touch or hold down upon a desired icon 44a-e to select the icon 44a-e. The selection of different icons 44a-e may initiate different respective operations or actions of the computing device 10 as discussed in additional detail below. Furthermore, in one embodiment, the selection of an icon 44a-e may change one or more characteristics of the selected icon. In one more specific example, all of the icons 44a-e may be displayed in phantom (e.g., a grey color) and a selected icon may be changed to a color different than grey (e.g., blue) to indicate the selected status of the icon 44a-e.

In one example where a user may have already launched an augmented reality browser, the user may activate the icon interface 40 where the icons 44a-e are displayed as shown in FIG. 3. In one embodiment, selection of some of the icons 44a-e may implement or change augmented reality operations of the computing device 10 or control operations of an executed augmented reality browser. For example, if a user selects icon 44a, the computing device 10 may activate an appropriate QR plugin for the augmented reality browser and which will configure the browser to search for QR markers and to display augmented reality content once a QR marker is detected. The selection of icon 44d instructs the computing device 10 to search for Myspace® markers for triggering Myspace® augmented reality content. In some embodiments, selection of an icon may deactivate, disable or turn off a plugin associated with the icon.

Accordingly, in one embodiment, the selection of one of the icons 44a-e may result in the depiction of augmented reality content with respect to an image being shown in the camera view. For example, while the augmented reality browser is being executed, the user may observe a marker of interest in the physical world. The user may utilize the icon interface 40 to select an appropriate icon to activate a plugin which corresponds to the type of marker, and thereafter the display screen 12 may depict an image of the real world including augmented reality content for the marker. In one embodiment, the display screen 12 may depict an image which includes the marker during the selection of the icon, and thereafter, the augmented reality content may be added to the depicted image corresponding to the location of the marker and replacing the marker in the displayed image.

Selection of others of the icons 44a-e may result in different operations. For example, selection of icon 44a instructs the computing device 10 to connect with a specified web page where the user may create a QAR™ code which may thereafter be detected by execution of the browsART™ augmented reality browser and used to trigger display of augmented reality content.

Selection of the icon 44b may result in the display of an information or help page while the selection of icon 44c may result in the display of a settings page. The pages displayed resulting from the selection of icons 44b and 44c may include information regarding an augmented reality browser and allow a user to change operations of an augmented reality browser in one embodiment.

In other embodiments, one or more of the icons 44a-e of the icon interface 40 may be associated with applications or content which are different than an application (e.g., browsAR™) which is currently being executed. For example, one or more of the icons may direct users to pages, applications, websites, etc. different than the currently-executed application, and/or control other operations or functions of computing device 10. In some embodiments, the computing device 10 may continue to execute an augmented reality browser, maintaining the computing device 10 in a camera view mode, during display and/or selection of at least some of the icons 44a-e.

Different icons 44a-e may be displayed differently by icon interface 40 in different embodiments. In the example illustrated embodiment, icons 44a-e are displayed at different locations along pathway 46. In one more specific embodiment, the location at the middle or center of the pathway 46 may be referred to as a primary location and the other icon locations may be referred to as secondary locations. Furthermore, the primary location may be at other positions of the slider pathway 46 in other embodiments.

In one embodiment, the icons 44a-e which are depicted at the different locations may be displayed with different characteristics. For example, an icon positioned at the primary location (i.e., icon 44a in the example of FIG. 3) may be depicted larger in size than the icons 44b-e positioned at the secondary locations. Furthermore, in one embodiment, the icon 44a positioned at the primary location may be solid or 100% opaque while the icons 44b-e positioned at the secondary locations may be less opaque revealing other features underneath the respective icons, such as pathway 46, or perhaps portions of images captured by the camera of the computing device 10.

In some embodiments, the characteristics of the icons 44a-e may be displayed at different degrees or extents corresponding to the distances of the icons 44b-e with respect to the icon 44a at the primary location. For example, the icons located farther away from the primary location (i.e., icons 44c, e) may be smaller in size and less opaque compared with icons closer to the primary location (i.e., icons 44b, d).

In addition, textual content 48 (e.g., “Create a OAR”) may also be displayed adjacent to and identify the icon 44a located at the primary location of the icon interface 40 in one embodiment. Other embodiments of icon interface 40 are possible for displaying icons 44a-e with different characteristics at the different locations. In addition, a user may select any of the icons 44a-e regardless of their locations along the pathway 46 in one embodiment.

In some embodiments, more icons may be available or utilized than are capable of being simultaneously depicted upon the display screen 12 using the icon interface 40 at a given moment in time, and a user may move or scroll the icons 44a-e to observe additional icons in one embodiment. In the presently-described example, the icons 44a-e are located along pathway 46 which may be considered to be a virtual track which provides predefined movement by guiding the icons 44a-e along the pathway 46. For example, the icons 44a-e may only move in opposing directions along the pathway 46 (e.g., upwards and downwards in the depicted example) and the icons 44a-e may not depart from pathway 46 in one embodiment.

In one embodiment, the computing device 10 is configured to monitor for the presence of a user input which specifies movement of the icons 44a-e along the pathway 46. In one more specific example, the computing device 10 is configured to monitor for the presence of a user input having a swiping movement 50 in a direction corresponding to a direction of the pathway 46. For example, in the embodiment of FIG. 3 where pathway 46 generally extends vertically, the computing device 10 may monitor for the presence of a user input having a swiping movement 50 in either an upward or downward direction, and move the icons 44a-e as a result of the detection of such a user input proximate to the icon interface 40. For example, the computing device 10 may move the icons 44a-e upward as a result of a user making an upward swiping movement 50, or move the icons 44a-e downward as a result of a user making a downward swiping movement 50. In one embodiment, the computing device 10 monitors for the presence of user inputs proximate to and in directions of the pathway 46 to sense the user inputs and to control the movement of the icons 44a-e in accordance with the detected user input movements 50.

In response to an upward swiping user input 50, the icon 44e may be paged off of the display screen 12 and another icon may move from below icon 44c and replace icon 44c to be viewable on the display screen 12 as the icons 44a-e move upwards. Similarly, the icons 44a-e may be moved downward to display additional icons located above icon 44e on the pathway 46 as a result of a detected downward user swiping movement 50.

In one embodiment, the icons 44a-e are arranged in an order which is maintained during navigation, such as scrolling of the icons. For example, if icon 44e is scrolled off the top of the display screen 12, another downward swiping motion 50 will return the icon 44e to the display screen 12. In some embodiments, the icons are arranged having fixed top and bottom icons whereupon the scrolling ends once the user navigates to the top or bottom icon. In another embodiment, the icons may be arranged in a loop where the icons continuously scroll off the top and may return at the bottom of the icon interface 40. The example of FIG. 3 is for illustration and discussion of various aspects of the disclosure and other embodiments are possible

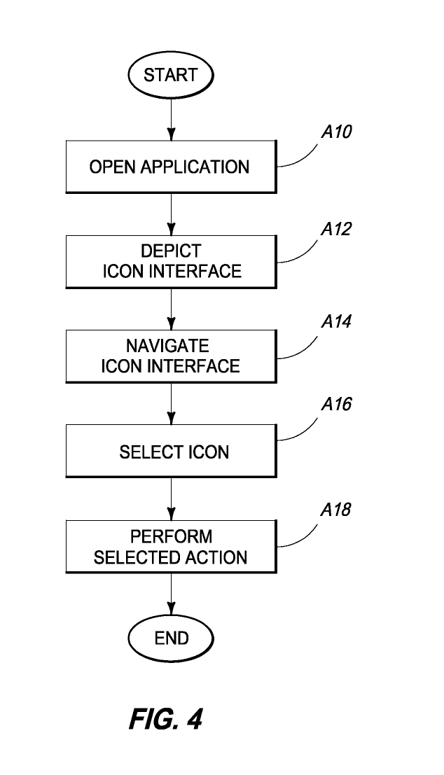

Referring to FIG. 4, one example method which may be executed is shown according to one embodiment. The method may be executed by processing circuitry of the computing device in but one implementation. Other methods are possible including more, less and/or alternative acts.

At an act A10, a user may open an application, such as an augmented reality browser. The computing device may display a camera view as a result of the application being opened. The icon interface discussed above may be a part of the browser in one implementation, and the computing device may monitor for an appropriate user input to activate the icon interface as discussed above in one embodiment. In one embodiment, the user may be prompted to perform an action. For example, an arrow similar to arrow 42 of FIG. 3 may be depicted on the display screen to indicate to the user that they can horizontally swipe to activate the icon interface. Alternatively, the icon interface may be automatically displayed once an application is executed without additional user interaction specifying the display of the icon interface.

At an act A12, the computing device has detected the presence of an appropriate user input to activate the icon interface, and the icon interface is displayed as a result of the detection of the user input. For example, if a leftward swipe is detected adjacent to the right side of the display screen, the icon interface may slide leftward from the right side of the display screen. If an application is being executed upon activation of the icon interface, at least some of the icons of the icon interface may correspond to the application while others of the icons may correspond to other applications or other computing device functionality apart from the application being executed.

At an act A14, a user input navigating the icon interface is detected. In one embodiment, the detected user input may be an upward or downward swiping motion proximate to the icon interface. Different icons may be scrolled and displayed within the icon interface as a result of the detected swiping motion as discussed above. In addition, the scrolling of the icons may be in the direction of the swiping motion in one embodiment.

At an act A16, a user input selecting one of the icons, for example by touching the icon, may be detected. The selection of an icon may control the computing device to install a plugin, connect to a page, or perform other operations with respect to an application being executed by the computing device or with respect to another application or other operation. The display screen may be provided in the camera view mode during the display of the icon interface and detection of user interactions with the icon interface in one embodiment. For example, an image may be displayed by the display screen while a user activates and navigates the icon interface.

Following a predefined period of inactivity with respect to the icon interface (e.g., a number of seconds), the icon interface may slide back to the side of the display screen where the icon interface is no longer visible in one embodiment.

At least some embodiments of the present disclosure provide methods, apparatus and programming for implementing an icon interface where different icons may be navigated, viewed and selected. The icon interface may be displayed during execution of an application (e.g., augmented reality browser) and the icons which are displayed may correspond to actions pertinent to the executed application and/or different applications or operations of the computing device in example embodiments discussed above.

The protection sought is not to be limited to the disclosed embodiments, which are given by way of example only, but instead is to be limited only by the scope of the appended claims.

Further, aspects herein have been presented for guidance in construction and/or operation of illustrative embodiments of the disclosure. Applicant(s) hereof consider these described illustrative embodiments to also include, disclose and describe further inventive aspects in addition to those explicitly disclosed. For example, the additional inventive aspects may include less, more and/or alternative features than those described in the illustrative embodiments. In more specific examples, Applicants consider the disclosure to include, disclose and describe methods which include less, more and/or alternative steps than those methods explicitly disclosed as well as apparatus which includes less, more and/or alternative structure than the explicitly disclosed structure.

The invention claimed is:

1. An augmented reality user interaction method comprising:
using a computing device, executing an augmented reality browser application;
during the executing, displaying a camera view of the computing device wherein a plurality of images generated by a camera of the computing device are displayed using a touch sensitive display;
during the displaying the camera view, displaying an icon interface comprising a pathway and a plurality of icons with respect to the pathway using the touch sensitive display;
first detecting a user input moving in a direction of the pathway;
moving the icons along the pathway in the direction of the user input as a result of the first detecting;
second detecting a user input selecting one of the icons; and
depicting augmented reality content with respect to at least one of the images as a result of the second detecting.

2. The method of claim 1 wherein the displaying comprises displaying one of the images during the second detecting without the augmented reality content, and the depicting comprises depicting the augmented reality content with respect to the one of the images.

3. The method of claim 1 wherein the pathway restricts the displayed icons to a predefined area of the displayed images.

4. The method of claim 1 further comprising displaying the camera view during the first detecting, the moving, the second detecting and the depicting.

5. The method of claim 1 wherein the displaying the camera view comprises initially displaying the camera view without displaying the icon interface, and the displaying the icon interface comprises displaying the icon interface during the camera view as a result of detecting a third user input.

6. A computing device comprising:
a display screen configured to depict an icon interface comprising a plurality of icons and a pathway, and to receive user inputs interacting with the display screen;
processing circuitry configured to control the display screen to depict the icon interface, to access the user inputs, and to control operations of the computing device as a result of the accessed user inputs; and
wherein the processing circuitry is configured to access one of the user inputs interacting with the icon interface depicted using the display screen and to control movement of the icons along the pathway of the icon interface as a result of the accessing the one of the user inputs.

7. The device of claim 6 further comprising a camera configured to generate a plurality of images, and wherein the processing circuitry is configured to control the display screen to simultaneously depict the images and the icon interface, and to depict augmented reality content with respect to content of one of the images as a result of another user input selecting one of the icons.

8. The device of claim 6 wherein movement of all the icons of the icon interface is restricted to the pathway.

9. The device of claim 6 wherein the processing circuitry is configured to access another of the user inputs selecting one of the icons, and to implement an operation of the computing device as a result of the selection of the one of the icons.

10. The device of claim 6 wherein the icons are depicted at a plurality of different locations along the pathway.

11. The device of claim 10 wherein one of the locations along the pathway is a primary location and others of the locations along the pathway are secondary locations, and one of the icons positioned at the primary location has a characteristic different than others of the icons positioned at the secondary locations.

12. The device of claim 6 wherein the pathway extends vertically between a top and a bottom of a display screen of the display screen.

13. The device of claim 12 wherein the pathway is depicted adjacent to one of the left and right sides of the display screen as a result of one of the user inputs interacting with an area of the display screen adjacent to a respective one of the left and right sides of the display screen.

14. The device of claim 13 wherein the pathway is depicted adjacent to the left side of the display screen as a result of the one of the user inputs comprising a swiping motion from the left to the right of the display screen and adjacent to the right side of the display screen as a result of the one of the user inputs comprising a swiping motion from the right to the left of the display screen

15. The device of claim 6 wherein the display screen comprises a touch sensitive display configured to detect presence and location of the user inputs which directly touch the display screen.

16. The device of claim 6 wherein the processing circuitry is configured to move the icons in one of a plurality of different directions along the pathway as a result of one of the user inputs moving in the one of the different directions.

17. An article of manufacture comprising:
storage media storing programming which causes processing circuitry of the computing device to perform processing comprising:
using a display screen, displaying a pathway and a plurality of icons at a plurality of different locations of the pathway;
accessing a user input with respect to the display screen;
as a result of the user input, moving the icons along the pathway;
as a result of a second user input, selecting one of the icons; and
implementing an operation of the computing device as a result of the selecting one of the icons.

18. The article of claim 17 wherein the programming further causes the processing circuitry to perform processing comprising:
accessing images from a camera of the computing device;
controlling the display screen to depict the images; and
wherein the implementing comprises displaying augmented reality content with respect to one of the images.

19. The article of claim 17 wherein the pathway limits the locations and the movement of the icons within the display screen.

20. The article of claim 17 wherein the accessing comprises accessing the user input comprising movement corresponding to the pathway, and the moving comprises moving the icons corresponding to the movement of the user input.
